(19) United States
(12) Patent Application Publication
(10) Pub. No.: US 2006/0115800 A1
(43) Pub. Date: Jun. 1, 2006

(54) System and method for improving reading skills of a student

(75) Inventor: Patrick Daley, Los Angeles, CA (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: SCHOLASTIC INC.

(21) Appl. No.: 11/265,490

(22) Filed: Nov. 2, 2005

Related U.S. Application Data
(60) Provisional application No. 60/623,852, filed on Nov. 2, 2004.

(51) Int. Cl. G09B 19/04

(52) U.S. Cl. 434/185

(57) ABSTRACT

A system and methods for improving the comprehension and oral presentation skills of a student are disclosed. Information and computer software stored and executed on a general purpose, multimedia computer provide a student with the ability to direct the operation of the computer to display and/or present audio recordings of instructional information, record the student's audio recitation of information, and play back such audio recordings. The system also provides a means to assess the level of skill that the student has acquired. This computer provides the student with the ability to direct the operation of the computer to display and/or present audio recordings of said language instruction information, record the student's audio recitation of information, and play back such audio recordings. The system also provides a means to assess the skill level of the student.

### CROSS-REFERENCE TO RELATED APPLICATIONS

This application claims benefit of U.S. Provisional Patent Application Ser. No. 60/623,852, entitled “System and Method for Improving Reading Skills as a Second Language,” filed Nov. 2, 2004, which is hereby incorporated by reference in its entirety for each of its teachings and embodiments.

### FIELD OF THE INVENTION

The present invention relates generally to the field of computer-based language training, and more particularly, to an automated system and method for teaching and improving communication skills in a target language, that is a second (or non-native) language.

### BACKGROUND OF THE INVENTION

The market for second and foreign language acquisition products is broad and growing, providing a multi-billion dollar market opportunity within the education and training sector. There is a demonstrated need for such products in several major market segments, including the education, corporate, government, and consumer markets, both in the United States and worldwide.

Educational institutions comprise the largest segment of the market opportunity. On a global basis, elementary through university level institutions teach English as part of their required curriculum, and over 1 billion students are enrolled in schools worldwide. The demand for effective materials for learning English outside the United States is growing in an ever-expanding global economy. In the United States, English as a Second Language (ESL) is growing in educational institutions due to an influx of immigrants, as well as increasing governmental regulations requiring students with limited English proficiency to move more quickly from bilingual and/or support classrooms to English-only classrooms. It can be reasonably estimated that millions of students per year worldwide are engaged in learning a second language.

Yet, traditional classroom teaching methods do not provide the individualized instruction necessary to improve the vastly different needs of second language students. Students in a classroom setting will receive the same instruction, and may need help learning certain skills that their peers have already mastered. Consequently, as they languish in a difficult, confusing situation, they fall behind in their instruction and progress, compounding their predicament.

The educational market dramatically showcases the failure of existing language learning programs. Many who have attempted to learn a foreign language in a classroom setting experience disappointment in regard to known methods. Virtually no one acquires a language from the classroom setting. While it is often believed that “living in the country” will facilitate learning the native language, the reality is that even living in the country is not enough for most adults. For example, living in the United States today are millions of adults who are enrolled in ESL classrooms, yet are still not finctional in English, despite both studying the language and living in the culture.

When under evaluation, many students have problems answering multiple choice questions. Often, a student presented with a multiple choice question and a set of possible answers will guess at the correct answer without thoroughly evaluating each of the answers.

Therefore, there exists a need for a computing platform that can help students to learn a second language more effectively. Students can learn a new language more easily if they receive patient, interactive instruction—such as that provided by a computer having multimedia capabilities. In particular, there is a need for an interactive system that improves the language comprehension and oral presentation skills of a student of a non-native language. In addition, there is a need for improving the student's ability to answer multiple choice questions.

### BRIEF SUMMARY OF THE INVENTION

The system and methods of the present application comprise one or more computers that preferably implement a course of instruction. Information and computer software stored and executed on a general purpose, multimedia computer provide a student with the ability to direct the operation of the computer to display and/or present audio recordings of instructional information, record the student's audio recitation of information, and play back such audio recordings. The system also provides a means to assess the level of skill that the student has acquired.

In one aspect, the present invention is directed to a method for improving oral presentation skills of a non-native speaking student of a target language, comprising: identifying a native language of the student from a plurality of languages; presenting a word in the target language; querying for help on the word; and providing a tip on the target language pronunciation of the word in response to said query.

In another aspect of the present invention, said tip is an audio recording presented in said native language.

In another aspect of the present invention, said query comprises selecting a control feature on a computer screen.

In another aspect of the present invention, said control feature comprises a button.

In another aspect of the present invention, said control feature reflects the identified native language of the student.

In another aspect of the present invention, said tip includes highlighting parts of the word.

In another aspect, the present invention is a system that improves oral presentation skills of a non-native speaking student of a target language, comprising: a database that stores a plurality of audio tips for a target language pronunciation of words, wherein each tip in said plurality is recorded in one or more languages; a display that shows the text of a word in the target language; a memory that stores information that identifies a native language of the student; an input device enabling the student to query for help on the word; and a processor that provides a tip from said plurality responsive to said query.

In another aspect of the present invention, said processor fetches and provides a tip recorded in said identified native language from said database.

In another aspect, the present invention is a method for improving comprehension skills of a student, comprising: selecting a multiple choice question comprising a question header and plurality of possible answers; presenting the question header; determining whether performance of the student answering the multiple choice question is below a minimum level; delaying presentation of possible answers if said performance is below the minimum level; and presenting each possible answer in the plurality of possible answers.

In another aspect of the present invention, the method further comprises: delaying between the presentation of each possible answer.

In another aspect of the present invention, an amount of the delay is zero if a student's performance on prior questions meets an minimum criteria based on correct answers.

In another aspect of the present invention, an amount of delay depends upon a total number of words in the question and each answer.

In another aspect of the present invention, the delay is increased in relation to an amount the student's performance is below the minimum level.

In another aspect of the present invention, an amount of delay depends upon a student's lexile level.

In another aspect, the present invention is a computer system that improves comprehension skills of a student, comprising: a database that stores multiple choice questions comprising a question header and plurality of possible answers; a processor and software code which causes said processor to fetch a multiple choice question from the database, determine whether performance of the student answering the multiple choice question is below a minimum level and calculate a delay between presentation of the question and a first answer, and between each of the plurality of possible answers; and a presentation device under control of said processor and software, that presents the question header to the student, the delay between the question header, each of the possible answers.

In another aspect of the present invention, said software causes said processor to delay between the presentation of each of the possible answers.

In another aspect of the present invention, an amount of the delay is zero if a student's performance on prior questions meets an minimum criteria based on correct answers.

In another aspect of the present invention, said software causes said processor to vary an amount of the delay depending upon a number of words in the question and each answer.

In another aspect of the present invention, said software causes said processor to vary an amount of the delay depending upon a student's lexile level.

### BRIEF DESCRIPTION OF THE DRAWINGS

FIG. 1 is a block diagram that illustrates a computer system that provides a foundation for presenting interactive language instruction;

FIG. 2 is a screen view of a passage of text;

FIG. 3A is a screen view of a power word help window;

FIG. 3B is a flow chart illustrating a method of enabling a student to seek decoding tips;

FIG. 4 is a flow chart illustrating a method of presenting a decoding tip;

FIG. 5 is a flow chart that illustrates a method of presenting a multiple choice test question;

FIG. 6A is a screen view of a word assessment screen;

FIG. 6B is a screen view that displays the results of the word assessment drill;

FIG. 7 is a screen view of a word clinic screen;

FIG. 8 is a screen view of a spelling assessment screen;

FIG. 9 is a screen view of a reading comprehension assessment screen;

FIG. 10 illustrates examples of recording media;

FIGS. 11A-C illustrate examples of decoding tips; and

FIGS. 12A-B illustrate preferred logic for highlighting.

### DETAILED DESCRIPTION OF THE INVENTION

The present invention comprises a system and methods for improving the comprehension and oral presentation skills of a student learning a course of instruction. The system and methods are preferably implemented as language instruction information and computer software stored and executed on a general purpose, multimedia computer. This computer provides the student with the ability to direct the operation of the computer to display and/or present audio recordings of said instruction information, record the student's audio recitation of information, and play back such audio recordings. The system also provides a means to assess the level of language skills that the student has acquired.

Additionally, the present invention may be described herein in terms of finctional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, or the like, with the various algorithms being implemented with any combination of data structures, objects, processes, routines or other programming elements. The computer code is preferably programmed in C++. The object code created can be executed by any computer having a Windows 98 or higher or MAC O.S. 9 or higher operating system.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified finctions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

System Architecture

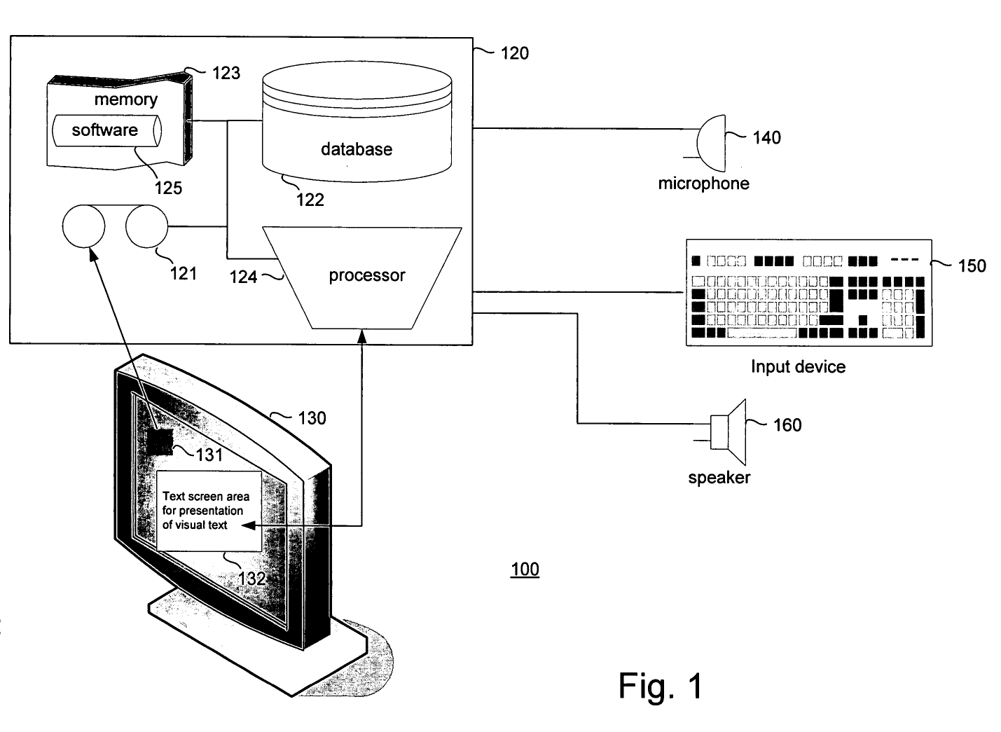

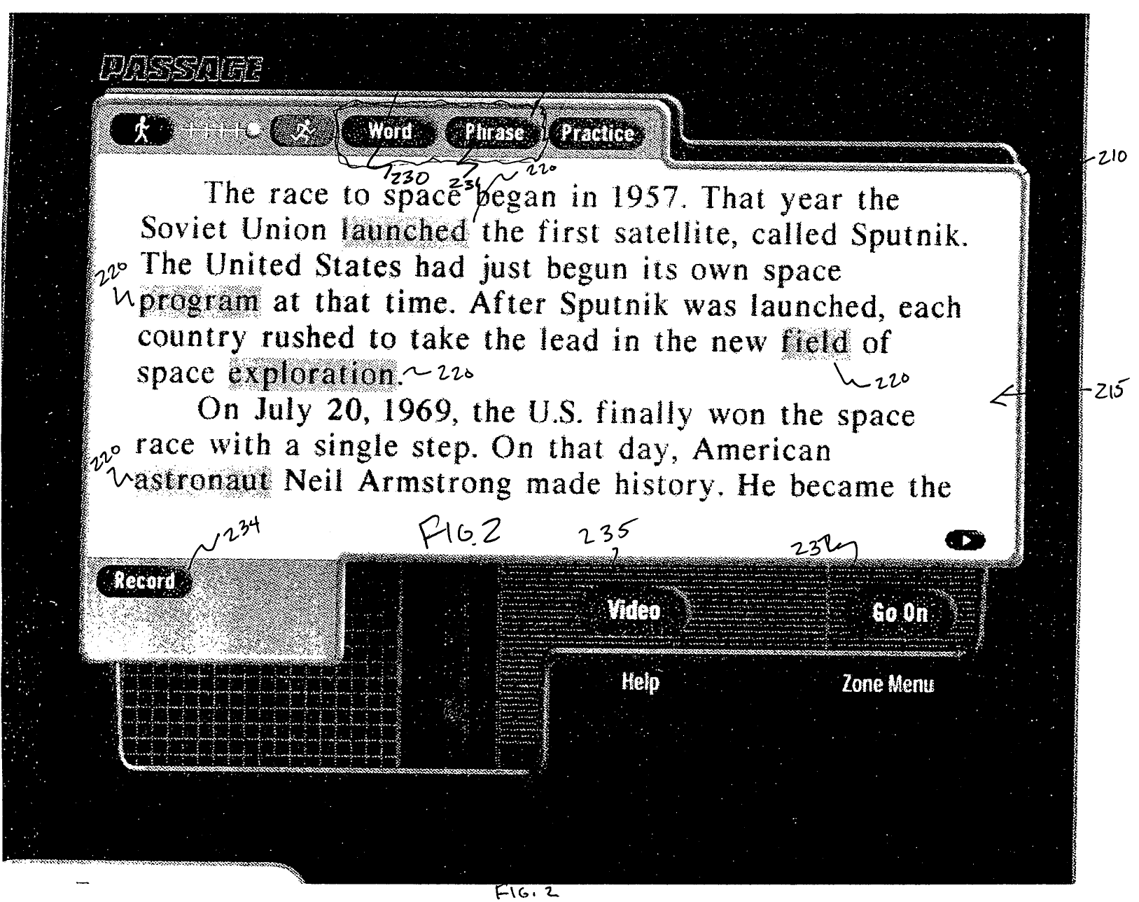

FIG. 1 is a block diagram that illustrates a computer system that provides a foundation for presenting interactive instruction. As shown in FIG. 1, system 100 comprises a computer 120 having various peripheral devices attached, comprising a display 130, a microphone 140, an input device 150 and speakers 160.

Computer 120 comprises an audio recording and playback device 121, a database 122 that stores information, a memory 123 and a processor 124 that executes software instructions 125 stored in memory 123. Audio recording and playback device 121 preferably comprises hardware that receives and records digitized audio signals into memory 123, and provides the user with the ability to select and play recorded digitized audio signals, as is well known in the art.

Display 130 comprises on-screen controls 131 that enable the user to manipulate the audio recording and playback device 121, and a visual text area for presenting textual information 132. Controls 131 are preferably graphically represented buttons, with symbols that are commonly found on a tape recorder or video tape recorder, that, when selected by input device 150, effect the operation of audio recording and playback device 121.

Microphone 140 provides the user with a means to record audio information, such as a passage of text read from display device 130.

Input device 150 may be a keyboard, mouse or other pointing device, or other information or control input device that affects the operation of computer 120, as is well known in the art.

Speakers 160 receive signals from audio recording and playback device 121 and emit audio output audible to the user. As is well known in the art, speakers 160 may also be a headset, and may also comprise microphone 140.

System Operation

The following discussion describes the methods performed by the inventive system. To provide context, the operation of an exemplary, preferred embodiment of software 125 is described.

On system 100 running said software 125, students see dynamic videos, hear customized audio support, and respond to engaging graphics. System 100 provides differentiated, adjusted instruction and practice in reading, vocabulary, speech fluency, spelling, and comprehension. Each student progresses by engaging in reading, word study and spelling activities from material arranged by topic.

In a reading activity, the student views a brief introductory video based on the current topic. The video provides background information that helps introduce the material that the student must comprehend. The video motivates the student by providing age-appropriate, high-interest content related to the topic. Optional text captioning provides video narration to encourage students to read along with the fluent audiovisual presentation and to support hearing impaired students. Students may also receive an audio summary of the video in their native language, to help them build a contextual background and understanding of the subject matter to be presented.

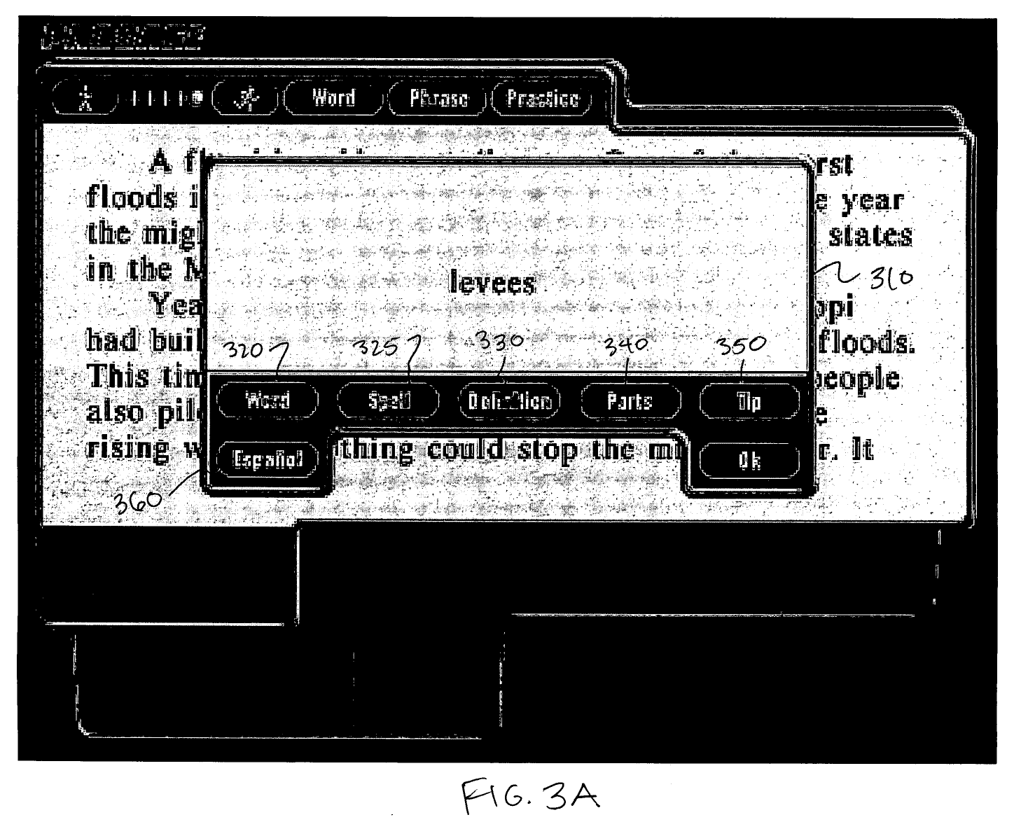

FIG. 2 is a screen view of a text passage 210 pulled from database 122 and presented to the student, comprising a plurality of words 215. As shown in FIG. 2, passage 210 comprises a series of targeted vocabulary words 220 that the student should learn from the passage, known as “power words.” On screen controls provide the student with the ability to interact with the system software 125. For example, each word may be double-clicked on to invoke a help feature, explained below. Controls further comprise buttons to select a mode of indicating the current point of narration 230, 231, navigation button 232, a record button 234 and a video player button 235. Navigation buttons 232 permits access to other activities or review the introductory video. Record button 234 is provided to enable students to record their reading of the passage using the audio recording and playback device 121 and microphone 140.

Text passage 210 is a leveled, lexiled passage tailored to ensure that the student works at his or her current instructional level. Passage 210 is seeded with phonics exemplars appropriate to the student's level. These exemplars come from a complete scope and sequence of phonic elements. These elements are presented to students as they proceed through the lessons. Passage 210 is also seeded with spelling patterns, high-frequency words, and content words that are appropriate for the student's reading level. These “seed” words appear again in the discrepancy and context passages of other modules to allow for multiple exposures to the words. (The targeted patterns and vocabulary words are listed for reference in the teacher's materials.) Passage 210 is preferably nonfiction, content-area text to help students build fluency and familiarity with text that they will encounter in all subject areas.

In operation, the student initially reads the passage aloud along with the audio narration of passage 210. As the passage is recited, the words in the passage are highlighted 240. Using the on-screen controls, the student may select whether the words are highlighted on a word-by-word 230 or phrase-by-phrase 231 basis. Following this recitation, the student may seek help on particular words, record themselves reciting the passage, or move on to other activities.

Software 125 guides students to repeated readings of connected text with varying levels of audio support at varying speeds. These repeated readings build students' word-recognition skills, reading fluency, and comprehension. Students build vocabulary skills as they learn about the preferable five to eight targeted vocabulary words.

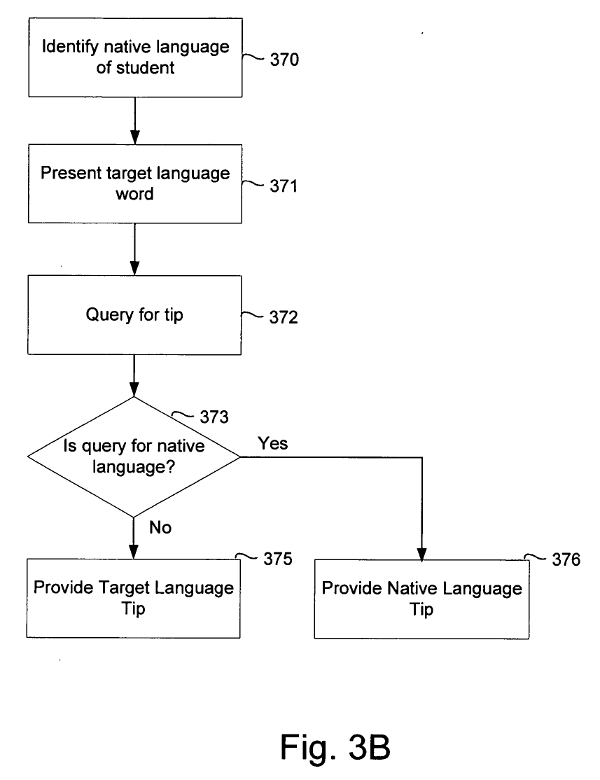

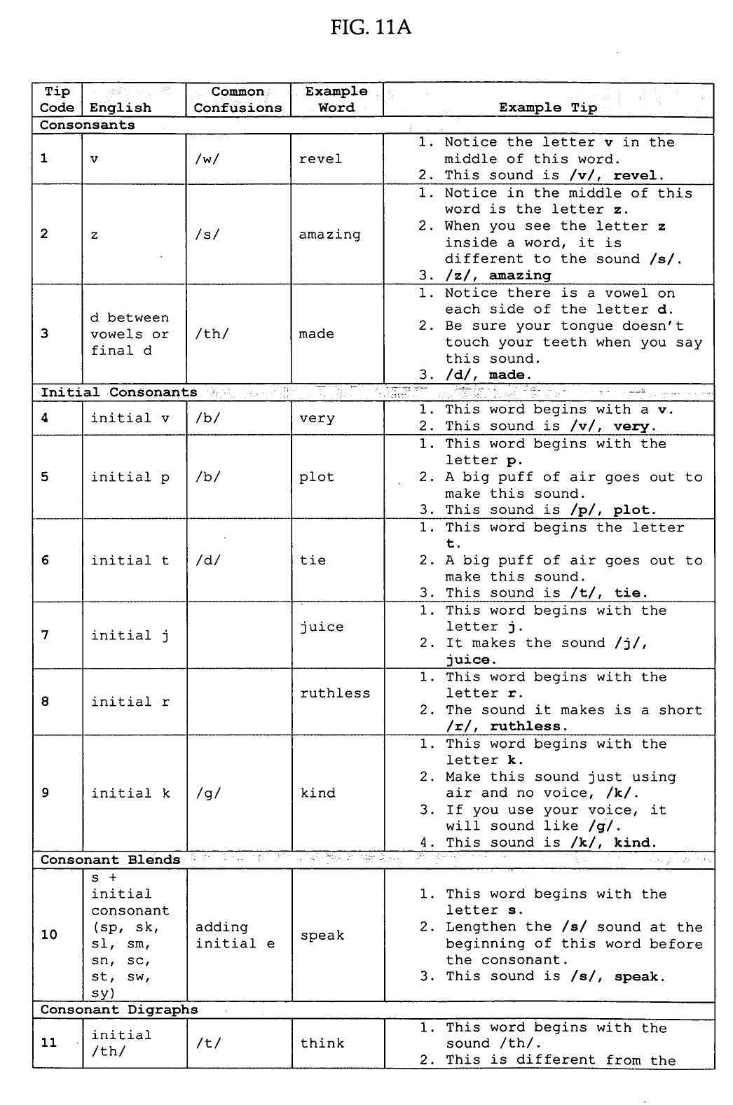

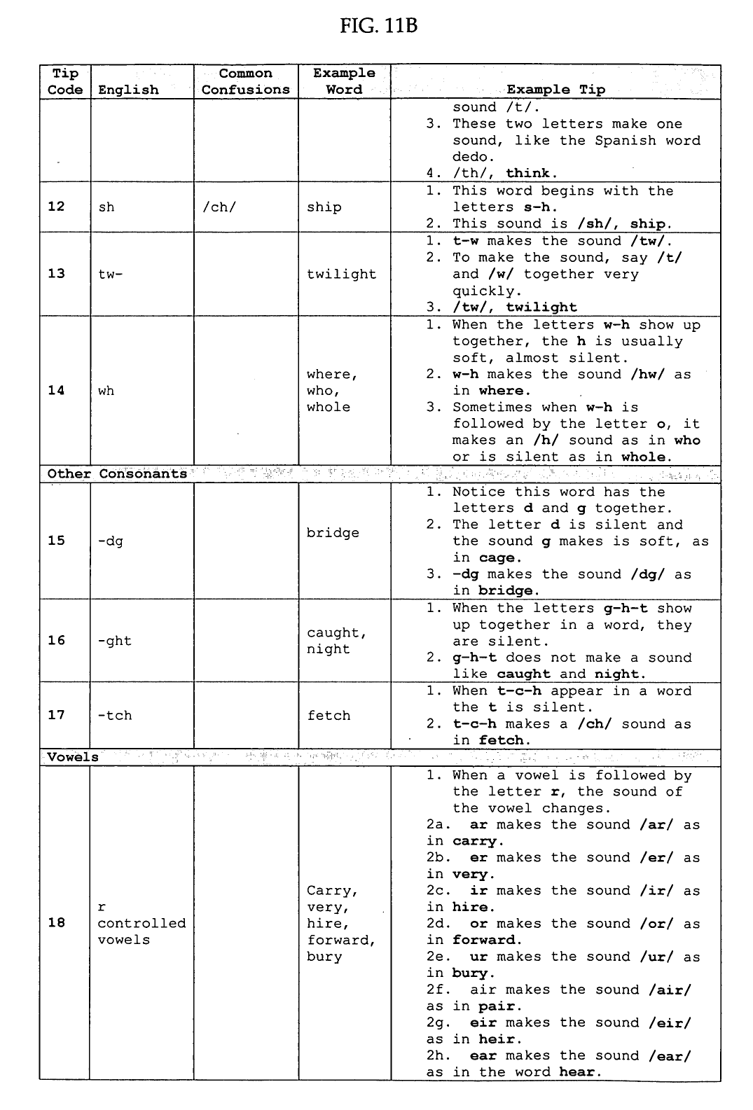

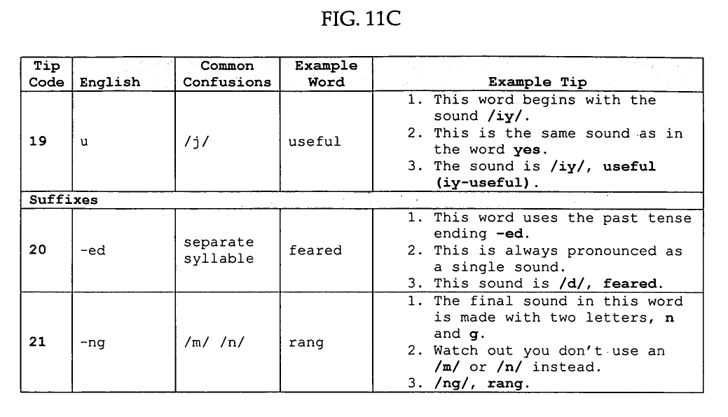

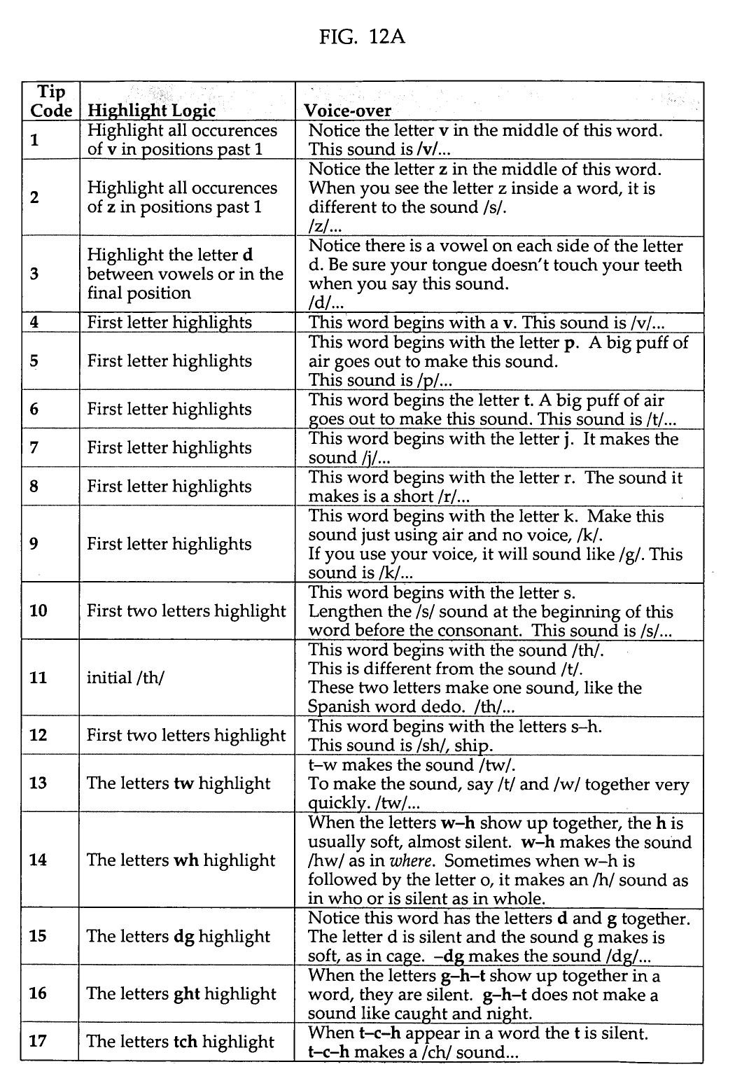

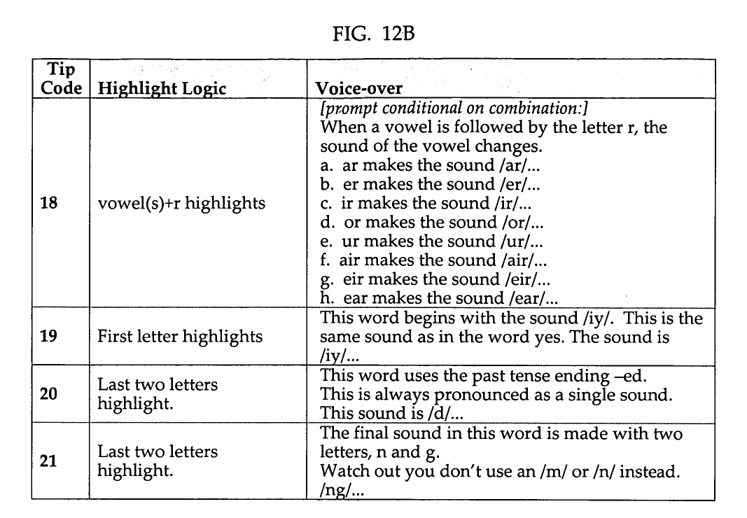

FIG. 3A is a screen view of a word help window. As illustrated in FIG. 3A, if a student double-clicks a word (see word 220 illustrated in FIG. 2), a separate word help window 310 opens. The student may then use on-screen controls to select an audio tip on the pronunciation of the word 320, the spelling of the word 325, the definition of the word 330, a breakdown of the word parts 340, a decoding of the word 350 presented in the target language, or a decoding of the word 360 presented in the native language. The word parts tip segments the word according to meaningful phonic elements and describes how the word is constructed. The decoding tip highlights important phonic elements and provides a strategy for applying these elements to the pronunciation of the word. Examples of these decoding tips are provided in FIGS. 11A-C. An exemplary, preferred logic for highlighting is presented in FIGS. 12A-B. Thus, the software provides support for words in response to a student's request for help, thereby providing differentiated instruction and assistance to meet individual student needs.

FIG. 3B is a flow chart illustrating a method of enabling a student to seek decoding tips. As shown in step 370 in FIG. 3B, the student's native language is identified. Next, in step 371, a target language word is presented. Such presentation may be the separate power word help window 310 illustrated in FIG. 3A, or may be merely a word in passage 210, and thus is not so limited. In step 372, the student queries for pronunciation help on the word. In step 373, system 100 determines whether the query is for help on the pronunciation, provided in the target language or in the native language. For example, as shown in FIG. 3A, buttons are provided so that the student may select a decoding tip in the target language (tip button 350) or the native language (as illustrated by the “Espanol” button 360). A target language tip is provided in step 375 if the query is for target language based help. Otherwise, a native language based tip is provided in step 376.

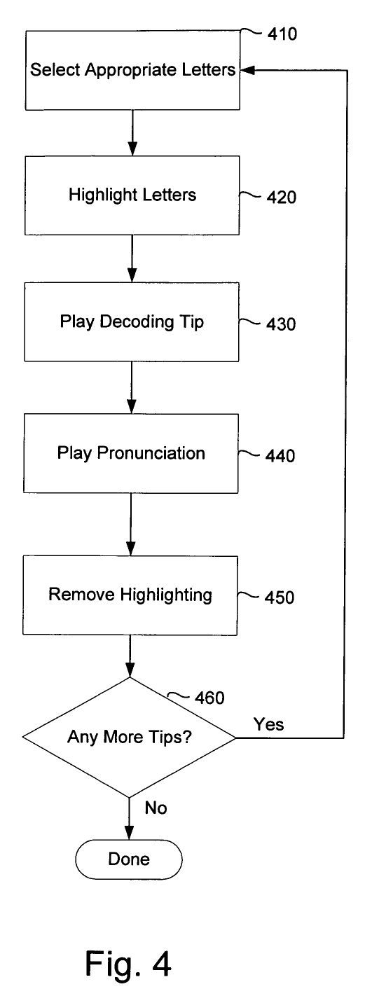

FIG. 4 is a flow chart illustrating a method of presenting a decoding tip, such as those provided in FIGS. 11 and 12. As shown in FIG. 4, at step 410, appropriate letters are selected in the word. In step 420, the appropriate letters in the word are highlighted. In step 430, system 100 plays an audio recording of the decoding tip. In step 440, system 100 presents a word pronunciation audio recording. In step 450, the highlighting is removed from the appropriate letters. In step 460, system 100 checks for remaining pronunciation tips in the word, and the process is repeated.

After the student completes the reading activity, the student's performance is assessed. The student is preferably asked to answer two multiple-choice questions based on passage 210 and the video. The questions test the student's comprehension and vocabulary in a format similar to standardized test questions. The comprehension skills preferably include: main idea, summarization, sequence of events, details, conclusion, inferences, cause and effect, compare and contrast, and problem and solution. The vocabulary words assessed are so-called power words that are frequently used in the language, or are related to the topic. Students may review passage 210 to find text evidence to assist them with providing answers. The student must correctly answer the questions before moving on to the next activity.

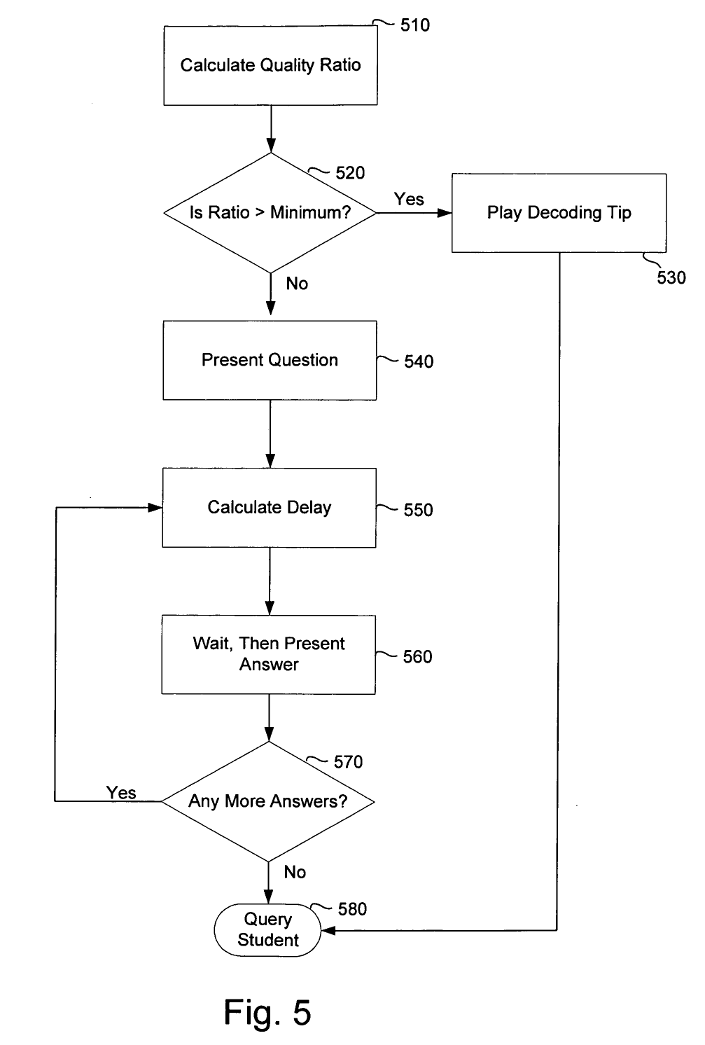

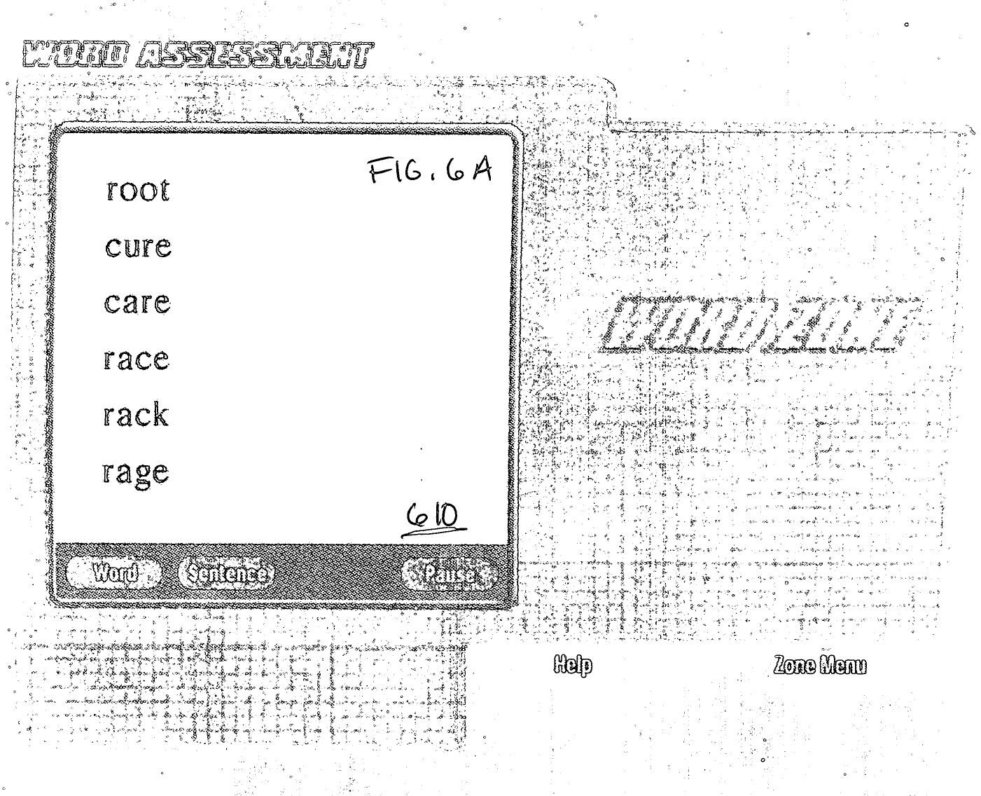

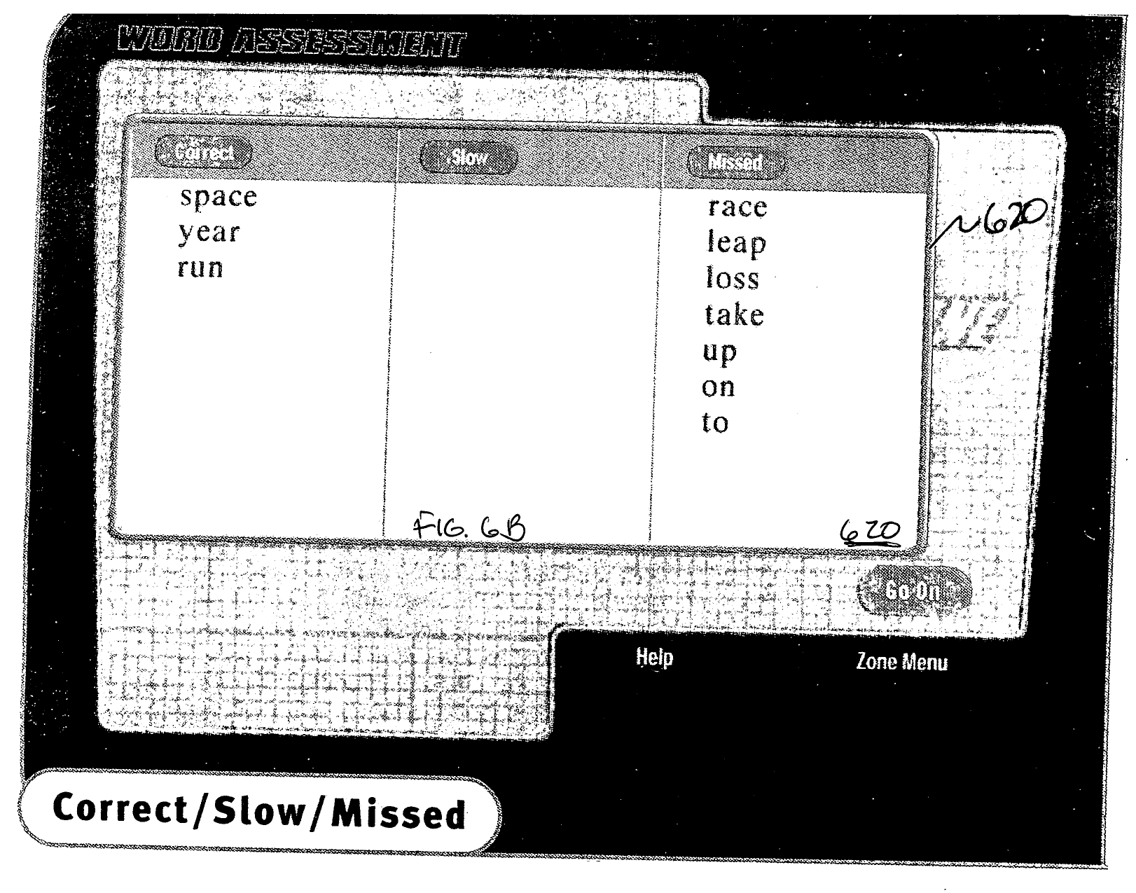

FIG. 5 is a flow chart that illustrates a method of presenting a multiple choice test question. In a multiple choice test, a student is presented with a question and several possible answers. Students who do not perform well on questions in multiple choice format often fail because they do not evaluate each possible answer. To overcome this problem, system 100 will stage the presentation of the question and each possible answer in turn. This staged presentation helps the student avoid the urge to guess or choose a single answer without considering all of the possible answers. As shown in step 510 of FIG. 5, to determine whether the student's performance warranted such staged presentation, a quality ratio is determined by dividing the number of correctly answered questions by the number of attempts historically provided by this student, limited by a predetermined number of attempts. For example, if the predetermined number of attempts is 10, and the number of questions the student has answered is greater than 10, then the number of correctly answered questions from the last 10 questions answered is divided by 10 to yield the quality ratio. If only 5 questions have been answered, then the number of correct answers is divided by 5. In step 520, the quality ratio is compared to a predetermined minimum amount. If the quality ratio is greater than the minimum amount, then in step 530, the student most likely does not need a staged presentation, so the question and all the answers are presented right away.

Otherwise, if the quality ratio is less than the minimum amount, in step 540, the student should have a staged presentation, so only the question is presented. In step 550, a delay is calculated, based on the just presented question or answer. Preferably, the delay is based on the number of words in the last presented question or answer, multiplied by a constant that represents a minimum amount of time required to read a word. Most preferably, the minimum amount of time is 0.2 seconds. In an alternative preferred embodiment, the delay is based on the student's lexile level. In step 560, an answer is presented after waiting for the delay calculated in step 560. In step 570, if not all the answers have been presented, steps 550 and 560 are repeated. In step 580, system 100 queries the student to select an answer.

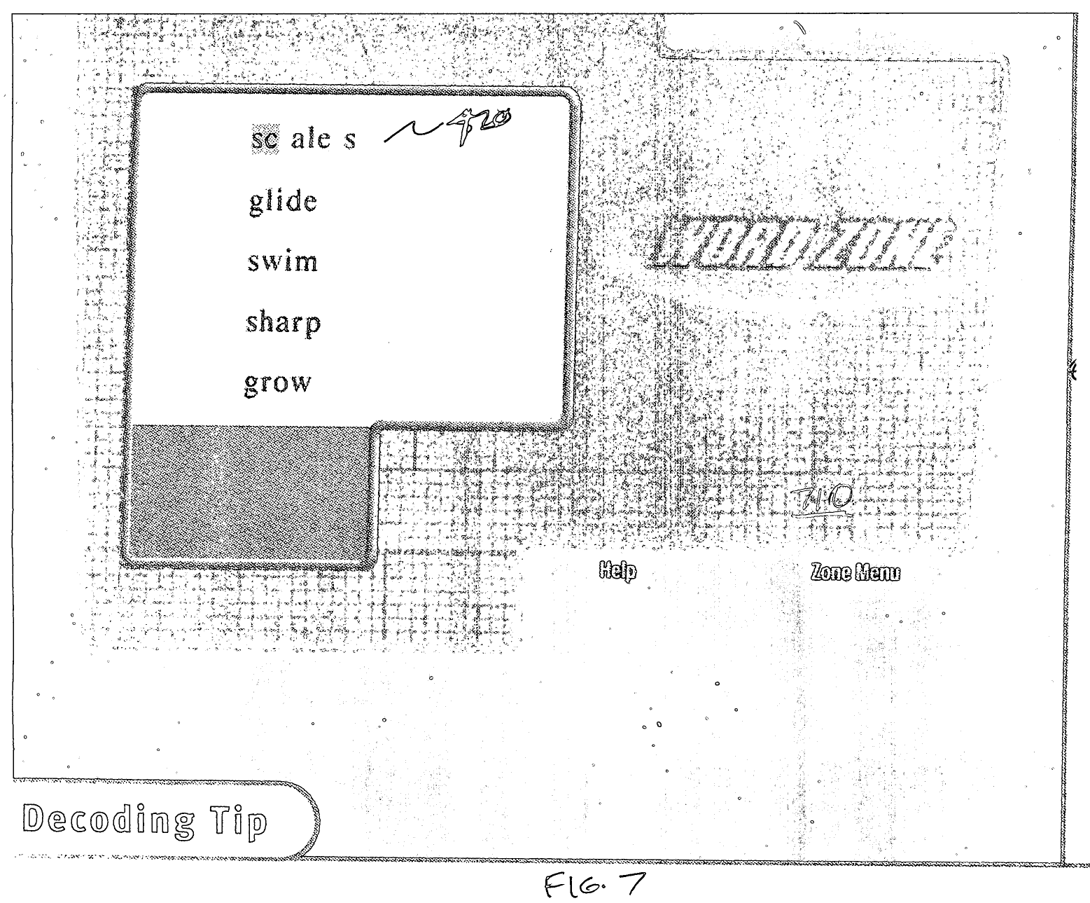

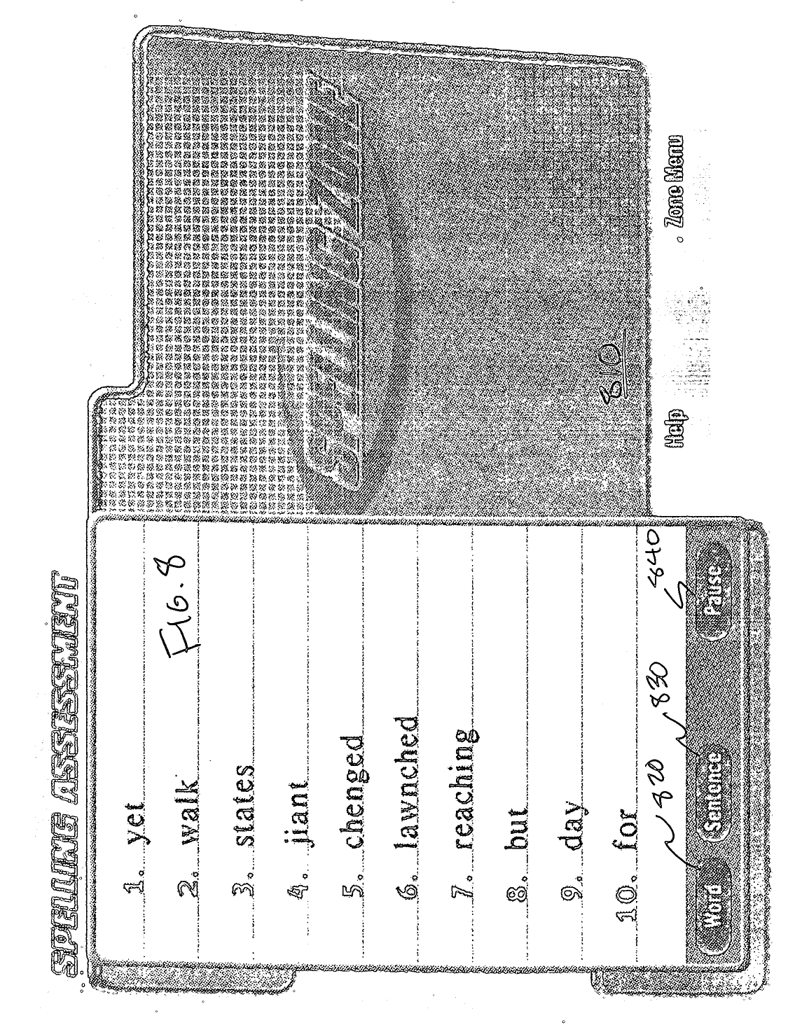

In the word study activity, the student is presented with a series of drills designed to test and reinforce the student's familiarization and understanding of words in passage 210 from the previous reading activity. FIG. 6A is a screen view of a word assessment screen 610 presented by software 125 to the student in a first drill. This drill assesses which words from passage 210 students are able to read and which ones they need further study.

As illustrated in FIG. 6A, in a preferred embodiment, a list of words, preferably six, are displayed. System 100 plays an audio recording reciting one of the words. The student must identify the recited word by clicking on it. This presentation and response check is repeated to preferably assess ten words, where each word is assessed three times. Students must differentiate among multiple words, known as distractors, to identify the word that they hear. To demonstrate mastery and fluency, students must preferably identify the word two out of three times correctly.

FIG. 6B is a screen view that displays the results of the word assessment drill. As shown in FIG. 6B, results screen 620 lists the words tested in three columns. The first column lists words that were correctly identified. The second column lists words that the student was slow to identify. The last column lists words that were missed by the student. In this fashion, the software monitors, tracks and reports the student's accuracy and speed identifying words.

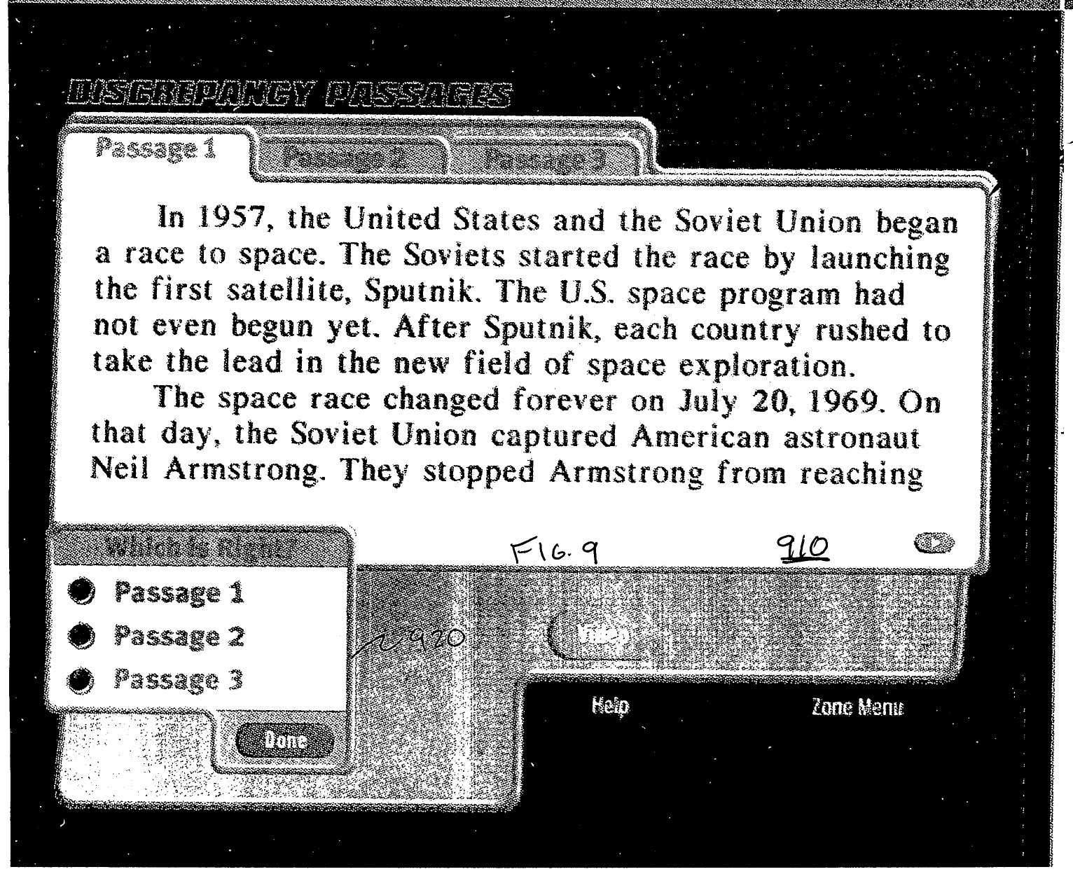

In a second word study drill, the student performs tasks designed to develop automatic recognition of words that were missed. FIG. 7 is a screen view of a word clinic screen. As shown in FIG. 7, screen 710 displays a short list of words that the student missed. The list is short to prevent overloading the student'attention and working memory. The student listens to a sample audio recording that pronounces each word and provides decoding support 720. The decoding support tips are customized for each word. The tips highlight common phonemic elements and provide word analysis strategies for the student. As explained above in connection with FIGS. 3A, 3B and 4, the student may double click on the word for additional pronunciation tips.

During the word study drill, the student can record his/her own pronunciation of the word. Each word can then be played back, and the student can compare his recording to the sample recording, and can approve or disapprove of his pronunciation. If the student disapproves, the student may re-record his pronunciation. Other word study drills include identifying a spoken word from a list of words on the screen and matching words with an equal number of spoken recordings, where the recording are identified by a graphic element.

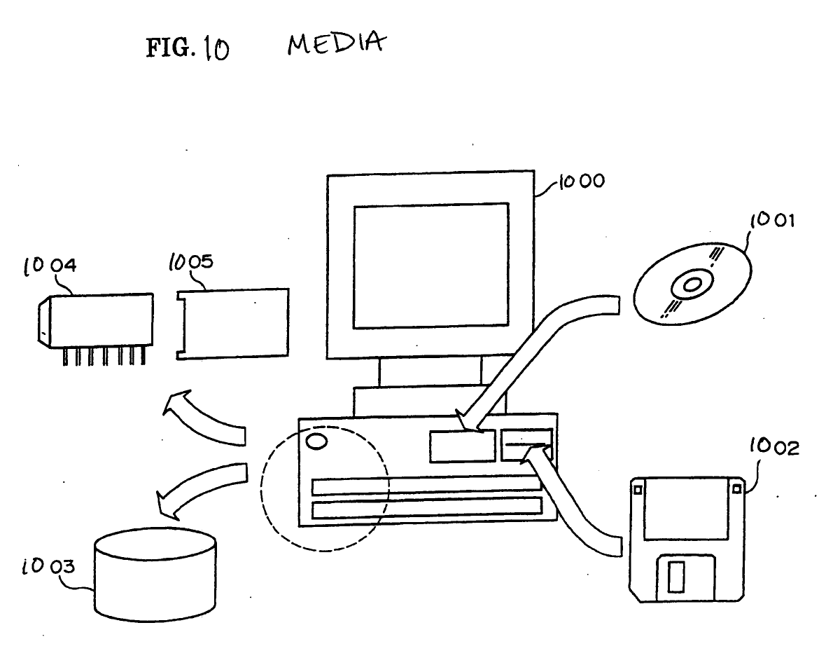

In a spelling activity, the student is presented with a series of drills designed to test and reinforce the student's ability to spell the targeted power words. These power words are drawn from passage 210. FIG. 8 is a screen view of a spelling assessment screen.

As illustrated in FIG. 8, in a preferred embodiment, system 100 plays an audio recording reciting one of a series of words displayed on screen view 810. The audio recording provides the pronunciation of the word and a sentence using the word. The student must type in the recited word within an allotted time period. The student may use on screen controls to replay the word 820, replay the sentence 830, or pause the drill 840. Additionally, as explained above in connection with FIGS. 3A, 3B and 4, the student may double click on the word for additional pronunciation tips. Following the entry of words, any misspelled words are identified and the correct spelling is provided to the student. If a certain minimum percentage of the words are spelled correctly, the student is permitted to progress to other, more difficult topics. Other spelling drills include immediate feedback of misspelled words, searching sentences and identifying misspelled words, and repeating these drills at increasing speed intervals.

During the spelling drills, system 100 provides spelling tips by breaking words into word parts. The spelling tips instructs the student how to identify important parts of the word, such as blends, inflectional endings, digraphs, common phonograms, etc. An audio recording provides recitation of the word part and blends of the word parts.

Reading comprehension activities are presented to the student once they have demonstrated a certain level of mastery of the words from the prior activities. In the reading comprehension activity, the student is presented with a series of drills designed to test the student's understanding of the words they've mastered. Students use higher-level thinking skills to evaluate information in different passages based on their knowledge of the original passage, to help build reading fluency. FIG. 9 is a screen view of a reading comprehension assessment screen.

As illustrated in FIG. 9, in a preferred embodiment, system 100 displays text for two or three similar passages in screen 910. Then, using on screen controls 920, the student selects the passage that is factually correct. Additionally, as explained above in connection with FIGS. 3A, 3B and 4, the student may double click on the word for additional pronunciation tips. In other comprehension drills, students record their reading of the passage to self-assess their own fluency, and select words to fill in the blanks provided in a template passage. These drills help to reinforce the student's understanding of the meaning of words in the passage.

Software on Media

In the specification, the term “media” means any medium that can record data therein. FIG. 10 illustrates examples of recording media.

The term “media” includes, for instance, a disk shaped media for 1001 such as CD-ROM (compact disc-read only memory), magneto optical disc or MO, digital video disc-read only memory or DVD-ROM, digital video disc-random access memory or DVD-RAM, a floppy disc 1002, a memory chip 1004 such as random access memory or RAM, read only memory or ROM, erasable programmable read only memory or E-PROM, electrical erasable programmable read only memory or EE-PROM, a rewriteable card-type read only memory 1005 such as a smart card, a magnetic tape, a hard disc 1003, and any other suitable means for storing a program therein.

A recording media storing a program for accomplishing the above mentioned apparatus maybe accomplished by programming functions of the above mentioned apparatuses with a programming language readable by a computer 1000 or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer processing device 1000, any suitable device for performing computations in accordance with a computer program may be used. Examples of such devices include a personal computer, a laptop computer, a microprocessor, a programmable logic device, or an application specific integrated circuit.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed is:

1. A method for improving oral presentation skills of a non-native speaking student of a target language, comprising:
identifying a native language of the student from a plurality of languages;
presenting a word in the target language;
querying for help on the word; and
providing a tip on the target language pronunciation of the word in response to said query.

2. The method of claim 1, wherein said tip is an audio recording presented in said native language.

3. The method of claim 1, wherein said tip is an audio recording presented in said target language.

4. The method of claim 1, wherein said query comprises selecting a control feature on a computer screen.

5. The method of claim 4, wherein said control feature comprises a button.

6. The method of claim 4, wherein said control feature reflects the identified native language of the student.

7. The method of claim 1, wherein said tip includes highlighting parts of the word.

8. A computer system that improves oral presentation skills of a non-native speaking student of a target language, comprising:
a database that stores a plurality of audio tips for a target language pronunciation of words, wherein each tip in said plurality is recorded in one or more languages;
a display that shows the text of a word in the target language;
a memory that stores information that identifies a native language of the student;
an input device enabling the student to query for help on the word; and
a processor that provides a tip from said plurality responsive to said query.

9. The system of claim 8, wherein said processor fetches and provides a tip recorded in said identified native language from said database.

10. A method for improving comprehension skills of a student, comprising:
selecting a multiple choice question comprising a question header and plurality of possible answers;
presenting the question header;
determining whether performance of the student answering the multiple choice question is below a minimum level;
delaying presentation of possible answers if said performance is below the minimum level; and
presenting each possible answer in the plurality of possible answers.

11. The method of claim 10, further comprising: delaying between the presentation of each possible answer.

12. The method of claim 11, wherein an amount of the delay is zero if a student's performance on prior questions meets an minimum criteria based on correct answers.

13. The method of claim 11, wherein an amount of delay depends upon a total number of words in the question and each answer.

14. The method of claim 12, wherein the delay is increased in relation to an amount the student's performance is below the minimum level.

15. The method of claim 11, wherein an amount of delay depends upon a student's lexile level.

16. A computer system that improves comprehension skills of a student, comprising:
a database that stores multiple choice questions comprising a question header and plurality of possible answers;
a processor and software code which causes said processor to fetch a multiple choice question from the database,
determine whether performance of the student answering the multiple choice question is below a minimum level and
calculate a delay between presentation of the question and a first answer, and between each of the plurality of possible answers; and
a presentation device under control of said processor and software, that presents the question header to the student, the delay between the question header, each of the possible answers.

17. The system of claim 16, wherein said software causes said processor to delay between the presentation of each of the possible answers.

18. The system of claim 17, wherein an amount of the delay is zero if a student's performance on prior questions meets an minimum criteria based on correct answers.

19. The system of claim 17, wherein said software causes said processor to vary an amount of the delay depending upon a number of words in the question and each answer.

20. The system of claim 17, wherein said software causes said processor to vary an amount of the delay depending upon a student's lexile level.
